(19) United States
(12) Patent Application Publication
(10) Pub. No.: US 2025/0354038 A1
(43) Pub. Date: Nov. 20, 2025

(54) IMPROVED METHOD FOR GLUING ONE OR MORE STRANDS OF GLASS-RESIN COMPOSITE, GRC

(71) Applicant: COMPAGNIE GENERALE DES ETABLISSEMENTS MICHELIN, Clermont-Ferrand (FR)

(72) Inventors: DELPHINE FLEURY, Clermont-Ferrand (FR); CHRISTOPHE CHAMBON, Clermont-Ferrand (FR)

(21) Appl. No.: 18/866,834

(22) PCT Filed: Apr. 6, 2023
(86) PCT No.: PCT/EP2023/059191

§ 371 Date: Nov. 18, 2024

(30) Foreign Application Priority Data
May 19, 2022 (FR) FR2204758

(51) Int. Cl. C09J 163/00; D01F 8/04

(52) U.S. Cl. CPC C09J 163/00; D01F 8/04; D10B 2101/06

(57) ABSTRACT

Sizing of one or more strands of glass-reinforced plastic (GRP): a) pre-bonding one or more strands of GRP plastic by dipping the strand(s) in a first aqueous bath comprising a composition based on an epoxy compound and a blocked diisocyanate compound; b) depositing on the GRP plastic strand(s) by dipping the GRP plastic strand(s) in a second bath comprising an aqueous adhesive composition based on at least one compound A1, the compound A1 comprising at least one aldehyde function, at least one phenol A21 and at least one unsaturated elastomer latex comprising at least one elastomer selected from butadiene copolymers, styrene-butadiene copolymers, vinyl pyridine-styrene-butadiene terpolymers, natural rubber, with the exception of chlorinated natural rubber, and mixtures thereof. The content of blocked diisocyanate compound in the aqueous adhesive composition of the second bath is at a weight content of strictly less than 0.50%.

The field of the present invention is that of glass-reinforced plastics, abbreviated to GRP, and adhesive compositions or “glues” intended to make such elements adhere to elastomer matrices, such as those commonly used in semi-finished elastomer articles or products, or else in the field of tyres or belts.

The present invention relates more particularly to an improved process for sizing one strand or several strands of glass-reinforced plastic GRP, to the elastomer composite comprising this sized GRP and to tyres reinforced by such elastomer composites.

Known from the prior art is a conventional process for sizing glass-reinforced plastics as described in application WO2016116457, where, conventionally, it is known practice to carry out the pre-bonding thereof in a first bath generally based on epoxy and isocyanate in aqueous solution, and then the glass-reinforced plastics are sized in a second bath with conventional aqueous adhesive compositions, for example adhesive compositions known under the name “RFL” (for resorcinol-formaldehyde latex), as described, for example, in EP2006341, mixed with an aqueous solution based on blocked diisocyanate, then mixed in an elastomer matrix with a 100% vinyl pyridine latex phase. The blocked diisocyanate is added to the adhesive composition at a weight content of 9% in order to improve the adhesion.

Also known from the prior art are processes for the adhesion of polyesters as described in application WO2021117519, but the mechanism of adhesion between an adhesive composition and the polyester is different from the mechanism of adhesion between an adhesive composition and a glass-reinforced plastic. In the mechanism of adhesion between the polyester and an adhesive composition, covalent bonds are formed between the polyester and the adhesive system and also secondary chemical bonds. The polyester is not very polar, thus a pre-bonding step is needed to enable adhesion. In the mechanism of adhesion between the glass-reinforced plastic and an adhesive composition as described in application WO2008061544, the glass-reinforced plastic was crosslinked beforehand, the chemical functions at the surface are different from those used between the polyester and an adhesive composition, and there is not necessarily a need for a pre-bonding treatment.

Thus, the designers of elastomer articles, notably tyre manufacturers, have the objective today of finding novel simple processes for making glass-reinforced plastics (GRPs) adhere satisfactorily to elastomer matrices, without these requiring the use of an adhesive composition in combination with products which have a negative impact on the environment. Furthermore, it is desirable for this adhesion to be initially, i.e. after cooling following the curing, relatively high and for this adhesion to be sparingly degraded under wet conditions.

In the course of its research, the Applicant has discovered a process which makes it possible to meet the above objectives.

The invention thus relates to a process for sizing one or more strands of glass-reinforced plastic, abbreviated to GRP, characterized in that it comprises the following steps:
a) carrying out a step of pre-bonding one or more strands of GRP plastic by dipping the or these strand(s) in a first aqueous bath comprising a composition based on:
   an epoxy compound; and
   a blocked diisocyanate compound;
b) carrying out a step of deposition on the GRP plastic strand(s) by dipping the GRP plastic strand(s) in a second bath comprising an aqueous adhesive composition based on:
   at least one compound A1, the compound A1 comprising at least one aldehyde function;
   at least one phenol A21;
   at least one unsaturated elastomer latex comprising at least one elastomer selected from the group consisting of butadiene copolymers, styrene-butadiene copolymers, vinyl pyridine-styrene-butadiene terpolymers, natural rubber, with the exception of chlorinated natural rubber, and the mixtures of these elastomers;
      the content of blocked diisocyanate compound in the aqueous adhesive composition of the second bath is at a weight content of strictly less than 0.50%.

The applicant thus hypothesizes that the pre-bonding step is an essential step in order, on the one hand, to maintain a good level of adhesion initially and, on the other hand, to guarantee resistance of the adhesive interface to wet conditions and/or to temperature, without however this requiring the use of blocked diisocyanate in the aqueous adhesive composition, it being desirable to reduce the amounts of which that are used.

The invention also relates to an elastomer composite reinforced with at least one or more sized glass-reinforced plastic (GRP) strands embedded in an elastomer matrix, in which the sized glass-reinforced plastic (GRP) strand(s) are obtained by the process as described above.

The composite according to the invention manufactured in this way can advantageously be used, notably for reinforcing pneumatic or non-pneumatic tyres of all types of vehicles, in particular passenger vehicles or industrial vehicles such as heavy vehicles or civil engineering vehicles, aircraft and other transport or handling vehicles.

The invention also relates to a tyre comprising the elastomer composite as described above.

The invention also relates to a belt comprising the elastomer composite as described above.

The process according to the invention allows an appreciable increase in the service life of the composites according to the invention, and thus of the tyres or belts comprising them, notably under wet conditions demonstrating the resistance of the adhesive interface created.

Any interval of values denoted by the expression “between a and b” represents the range of values extending from more than a to less than b (which is to say, excluding the end-points a and b), whereas any interval of values denoted by the expression “from a to b” means the range of values extending from a up to b (which is to say, including the strict end-points a and b).

Within the context of the invention, the carbon products mentioned in the description may be of fossil or biobased origin. In the latter case, they may be partially or completely derived from biomass or obtained from renewable raw materials derived from biomass.

In the present description, unless expressly otherwise stated, all the percentages (%) shown are % by weight.

The term “elastomer composition” means a composition comprising at least one elastomer (or, equally, rubber) and at least one other constituent.

A “diene” elastomer (or, equally, rubber) is understood as being an elastomer resulting at least partly (i.e. a homopolymer or a copolymer) from diene monomer(s) (i.e., monomer(s) bearing two conjugated or non-conjugated carbon-carbon double bonds). An “isoprene elastomer” is understood as being an isoprene homopolymer or copolymer, in other words a diene elastomer selected from the group consisting of natural rubber (NR), synthetic polyisoprenes (IRs), various isoprene copolymers and mixtures of these elastomers.

The term “elastomer matrix” means a matrix exhibiting elastomeric behaviour.

The term “meta position relative to one another” means that the hydroxyl functions are borne by carbons of the aromatic ring which are separated from one another by a single other carbon of the aromatic ring.

The term “in the position ortho to a function” means the position occupied by the carbon of the aromatic ring which is immediately adjacent to the carbon of the aromatic ring bearing the function.

The term “member” of a ring means a constituent atom of the backbone of the ring. Thus, for example, a benzene ring comprises six members, each member consisting of a carbon atom. In another example, a furan ring comprises five members, four members each consisting of a carbon atom and the remaining member consisting of an oxygen atom.

“CHO” represents the aldehyde function.

“CH₂OH” represents the hydroxymethyl function.

The term “aromatic polyphenol” means an aromatic compound comprising at least one benzene ring bearing more than one hydroxyl function.

The term “resin based on” should be understood as meaning that the resin includes the mixture and/or product of reaction of the various base constituents used for this resin as is defined above and that this resin is solely based on the constituents of the resin. Thus, the base constituents are the reactants intended to react together during the final condensation of the resin and are not reagents intended to react together to form these base constituents.

In accordance with the invention, the base constituents of the aqueous adhesive composition thus comprise at least one compound A1 and at least one phenol A21. In one embodiment, the base constituents can comprise other additional constituents different from compound A1 and from the phenol A21. In another embodiment, the base constituents are constituted of at least one compound A1 and of at least one phenol A21.

Preferably, in the embodiment where the base constituents comprise other additional constituents, these other additional constituents are free of formaldehyde and/or free of methylene donor selected from the group consisting of hexamethylenetetramine (HMT), hexamethoxymethylmelamine (H3M), hexaethoxymethylmelamine, lauryloxymethylpyridinium chloride, ethoxymethylpyridinium chloride, polymers of hexamethoxymethylmelamine of trioxane of formaldehyde, hexakis (methoxymethyl) melamine, N,N′, N″-trimethyl-N,N′,N″-trimethylolmelamine, hexamethylolmelamine, N-methylolmelamine, N,N′-dimethylolmelamine, N,N′, N″-tris (methoxymethyl) melamine and N,N′, N″-tributyl-N,N′, N″-trimethylolmelamine. More advantageously, these other additional constituents are free of formaldehyde and free of the methylene donors described in this paragraph.

More preferably, in the embodiment in which the base constituents comprise other additional constituents, these other additional constituents are free of formaldehyde and/or free of methylene donor selected from the group consisting of hexamethylenetetramine, hexaethoxymethylmelamine, hexamethoxymethylmelamine, lauryloxymethylpyridinium chloride, ethoxymethylpyridinium chloride, hexamethoxymethylmelamine of trioxane and the N-substituted oxymethylmelamines corresponding to the general formula:

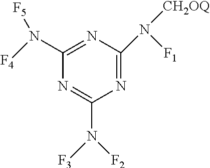

in which Q represents an alkyl group containing from 1 to 8 carbon atoms; F₁, F₂, F₃, F₄ and F₅ are selected, independently of one another, from the group consisting of a hydrogen atom, of an alkyl group containing from 1 to 8 carbon atoms, of the group —CH₂OQ and the condensation products thereof. More advantageously, these other additional constituents are free of formaldehyde and free of the methylene donors described in this paragraph.

Even more preferentially, in the embodiment in which the base constituents comprise other additional constituents, these other additional constituents are free of formaldehyde and/or free of methylene donor. More advantageously, these other additional constituents are free of formaldehyde and free of methylene donors.

The term “free of formaldehyde or free of methylene donor” means that the total weight content of formaldehyde or of methylene donor(s) belonging to the groups described above, relative to the total weight of the compound(s) A1 in the base constituents is less than or equal to 10%, preferably less than or equal to 5%, more preferentially less than or equal to 2% and even more preferentially less than or equal to 1%.

The term “free of formaldehyde or free of methylene donor” means that the total weight content of formaldehyde and of methylene donor(s) belonging to the groups described above, relative to the total weight of the compound(s) A1 in the base constituents, is less than or equal to 10%, preferably less than or equal to 5%, more preferentially less than or equal to 2% and even more preferentially less than or equal to 1%.

The term “strands of glass-reinforced plastic GRP” means composite reinforcers based on monofilaments of GRP type comprising continuous unidirectional multifilament glass fibres embedded in a thermoset resin and which can be used in particular as reinforcing elements for tyres.

### PROCESS ACCORDING TO THE INVENTION

### A) Pre-Bonding Step

The pre-bonding of the GRP strand(s) is carried out in a first bath based on epoxy and blocked diisocyanate in aqueous solution.

Advantageously, the epoxy compound is selected from the group consisting of diethylene glycol diglycidyl ether, polyethylene diglycidyl ether, polypropylene glycol diglycidyl ether, neopentyl glycol diglycidyl ether, 1,6-hexanediol diglycidyl ether, glycerol polyglycidyl ether, trimethylolpropane polyglycidyl ether, polyglycerol polyglycidyl ether, pentaerythritol polyglycidyl ether, diglycerol polyglycidyl ether, sorbitol polyglycidyl ether or isosorbide diglycidyl ether, and preferably is polyglycerol polyglycidylether.

Advantageously, the blocked diisocyanate compound is selected from the group consisting of diphenylmethane diisocyanate or polyphenylene polymethylene polyisocyanate and preferably N,N′-(methylenedi-p-phenylene)bis[hexahydro-2-oxo-1H-azepine-1-carboxamide 4,4′-diisocyanate.

Advantageously, this pre-bonding step is followed by a step of drying the GRP plastic at a temperature above or equal to 120° C. for at least 5 seconds followed by a heat treatment at a temperature above or equal to 180° C. for at least 5 seconds.

### B) Step of Depositing the Aqueous Adhesive Composition

An aqueous adhesive composition is then deposited on the pre-bonded GRP strand(s).

In accordance with the invention, the base constituents of the resin thus comprise at least one compound A1 and at least one phenol A2. In one embodiment, the base constituents can comprise other additional constituents different from compound A1 and from the phenol A2. In another embodiment, the base constituents are constituted of at least one compound A1 and of at least one phenol A2.

According to the invention, the aqueous adhesive composition is prepared so that the blocked diisocyanate is at a weight content in the aqueous adhesive composition of strictly less than or equal to 0.50%.

Preferably, the blocked diisocyanate compound in the aqueous adhesive composition of the second bath is at a weight content of strictly less than 0.40%, preferably less than or equal to 0.30%, more preferentially less than or equal to 0.20%, more preferentially less than or equal to 0.10% and even more preferentially less than or equal to 0.05%.

More preferentially, the aqueous adhesive composition of the second bath is free of blocked diisocyanate.

### Compound A1

Another essential constituent of the adhesive composition is a compound A1, the compound A1 comprising at least one aldehyde function.

In accordance with the invention, the resin is based on at least one (i.e. one or more) compound A1.

In a first embodiment, the compound A1 is formaldehyde.

In a second embodiment, the compound A1 comprises at least one aromatic ring bearing at least one aldehyde function.

More preferentially, the compound A1 bears at least two aldehyde functions.

More preferentially still, the aromatic ring of the compound A1 bears two aldehyde functions.

In one embodiment, the aromatic ring of the compound A1 is selected from the group consisting of a benzene ring and a furan ring; preferably, the aromatic ring of the aromatic aldehyde is a benzene ring.

Preferably, the compound A1 is selected from the group consisting of 1,2-benzenedicarboxaldehyde, 1,3-benzenedicarboxaldehyde, 1,4-benzenedicarboxaldehyde, 2-hydroxybenzene-1,3,5-tricarbaldehyde and the mixtures of these compounds.

In one variant of the second embodiment, the compound A1 is of general formula (A):

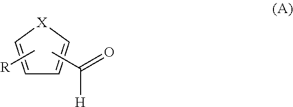

in which:
X comprises N, S or O,
R represents —H or —CHO.

Preferentially, the compound A1 is of general formula (A′):

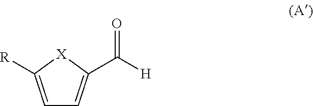

in which X represents O.

More preferentially still, R represents-CHO.

According to a preferred embodiment, X represents O.

In one variant of the compound A1 of general formula (A), X represents O and R represents —H. The compound A1 used is then of formula (Ba):

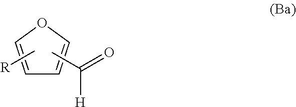

In one variant of the aldehyde of general formula (A′), X represents O and R represents —H. The compound A1 used is then furfuraldehyde and is of formula (B′a):

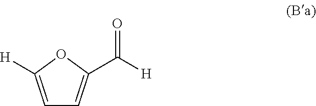

In another variant of the compound A1 of general formula (A), X represents O and R represents —CHO. The compound A1 used is then of formula (Bb):

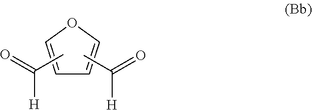

In another variant of the compound A1 of general formula (A′), X represents O and R represents —CHO. The compound A1 used is then 2,5-furandicarboxaldehyde and is of formula (B′b):

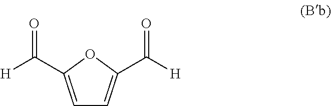

In another embodiment, X comprises N.

Preferably, the compound A1 is selected from the group consisting of furfuraldehyde, 2,5-furandicarboxaldehyde and the mixtures of these compounds.

In one variant of the compound A1 of general formula (A), X represents NH. The compound A12 used is of formula (Ca):

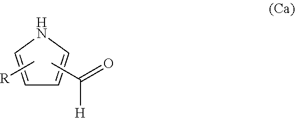

In one variant of the compound A1 of general formula (A′), X represents NH. The compound A12 used is of formula (C′a):

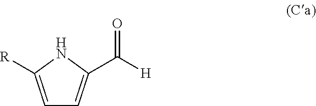

Preferably, R represents —CHO in the variant of the compound A12 of formula (C′a) and the compound A12 obtained is then 1H-pyrrole-2,5-dicarboxaldehyde.

In another variant of the compound A1 of general formula (A), X represents NT₁ with T₁ representing an alkyl, aryl, arylalkyl, alkylaryl or cycloalkyl group. The compound A12 used is of formula (Cb):

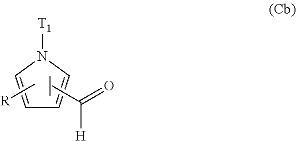

In another embodiment, X comprises S.

In one variant of the compound A1 of general formula (A), X represents S. The compound A12 used is of formula (Da):

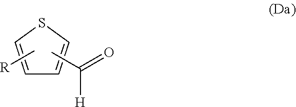

In one variant of the compound A1 of general formula (A′), X represents S. The compound A12 used is of formula (D′a):

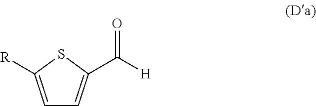

Preferably, R represents —CHO in the variant of the compound A1 of formula (IV′a) and is then 2,5-thiophenedicarboxaldehyde.

In another variant of compound A1 of general formula (A), X represents ST₂ with T₂ representing an alkyl, aryl, arylalkyl, alkylaryl or cycloalkyl group. The compound A12 used is of formula (Db):

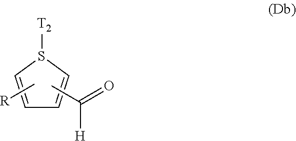

In yet another variant of the compound A1 of general formula (A), X represents T₃-S-T₂ with T₂ and T₃ each representing, independently of one another, an alkyl, aryl, arylalkyl, alkylaryl or cycloalkyl group. The compound A1 used is of formula (Dc):

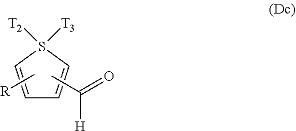

In yet another variant of the compound A1 of general formula (A), X represents S═O. The compound A12 used is of formula (Dd):

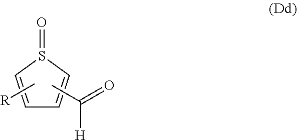

In yet another variant of the compound A1 of general formula (A), X represents O═S═O. The compound A12 used is of formula (De):

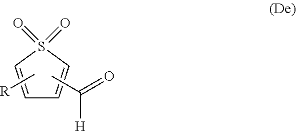

Among the various embodiments described above, preference will be given to the embodiments and variants in which X represents NH, S or O. In these embodiments and variants, it will be possible for R to represent —H or —CHO and preferably for R to represent —CHO. In these embodiments and variants, R will preferentially be in the 5 position and the —CHO group will preferentially be in the 2 position on the aromatic ring (general formula (A′).

### Phenol A21

In accordance with the invention, the resin is based on at least one (i.e. one or more) phenol A21.

Advantageously, the phenol A21 is chosen from:
an aromatic polyphenol A2 comprising at least one aromatic ring bearing at least two hydroxyl functions in the meta position with respect to one another, the two positions ortho to at least one of the hydroxyl functions being unsubstituted;
an aromatic monophenol A2′ comprising at least one six-membered aromatic ring bearing a single hydroxyl function,
   the two positions ortho to the hydroxyl function being unsubstituted, or
   at least one position ortho to and the position para to the hydroxyl function being unsubstituted;
a mixture of A2 and A2′.

In one embodiment, the phenol is an aromatic polyphenol A2 comprising one or more aromatic ring(s). The aromatic polyphenol comprises at least one aromatic ring bearing at least two hydroxyl functions in the meta position with respect to each other, the two positions ortho to at least one of the hydroxyl functions being unsubstituted.

In another embodiment, the phenol is an aromatic monophenol A2′ comprising at least one six-membered aromatic ring bearing a single hydroxyl function. On this aromatic monophenol, the two positions ortho to the hydroxyl function are unsubstituted, or else at least one position ortho to the hydroxyl function, and the position para to the hydroxyl function, are unsubstituted.

In yet another embodiment, the phenol is a mixture of the aromatic polyphenol A2 and of the aromatic monophenol A2′ as described above.

In accordance with the invention, the aromatic polyphenol A2 can be, in one embodiment, a simple aromatic polyphenol molecule comprising one or more aromatic rings, at least one of these aromatic rings, indeed even each aromatic ring, bearing at least two hydroxyl functions in the meta position with respect to each other, the two positions ortho to at least one of the hydroxyl functions being unsubstituted.

Similarly, the aromatic monophenol A2′ may be, in one embodiment, a simple aromatic monophenol molecule comprising one or more six-membered aromatic rings, at least one of these six-membered aromatic rings, or even each six-membered aromatic ring, bearing a single hydroxyl function, the two positions ortho to the hydroxyl function are unsubstituted, or else at least one position ortho to the hydroxyl function, and the position para to the hydroxyl function, are unsubstituted.

Such simple molecules do not comprise a repeat unit.

In accordance with the invention, the aromatic polyphenol A2 can, in another embodiment, be a pre-condensed resin based on:
at least one aromatic polyphenol comprising at least one aromatic ring bearing at least two hydroxyl functions in the meta position with respect to each other, the two positions ortho to at least one of the hydroxyl functions being unsubstituted; and
at least one compound comprising at least one aldehyde function and/or at least one compound comprising at least two hydroxymethyl functions borne by an aromatic ring.

Such a pre-condensed resin based on aromatic polyphenol is in accordance with the invention and comprises, unlike the simple molecule described above, a repeat unit. In the case in point, the repeat unit comprises at least one aromatic ring bearing at least two hydroxyl functions in the meta position with respect to each other.

Similarly and in accordance with the invention, the aromatic monophenol A2′ may be, in another embodiment, a pre-condensed resin based on:
at least one aromatic monophenol comprising at least one six-membered aromatic ring bearing a single hydroxyl function:
   the two positions ortho to the hydroxyl function are unsubstituted, or
   at least one position ortho to the hydroxyl function, and the position para to the hydroxyl function, are unsubstituted;
at least one compound comprising at least one aldehyde function and/or at least one compound comprising at least two hydroxymethyl functions borne by an aromatic ring.

Such a pre-condensed resin based on aromatic monophenol is in accordance with the invention and comprises, unlike the simple molecule described above, a repeat unit. In the case in point, the repeat unit comprises at least one six-membered aromatic ring bearing a single hydroxyl function.

In another embodiment, the phenol A21 is a mixture of an aromatic polyphenol which forms a simple molecule and of a pre-condensed resin based on aromatic polyphenol.

In yet another embodiment, the phenol A21 is a mixture of an aromatic monophenol which forms a simple molecule and of a pre-condensed resin based on aromatic monophenol.

In the specific embodiments which follow, the aromatic ring(s) of the aromatic polyphenol and/or of the aromatic monophenol is (are) described. For the sake of clarity, the “aromatic polyphenol” and/or the “aromatic monophenol” is described therein in its simple molecule form. This aromatic polyphenol and/or this aromatic monophenol will subsequently be able to be condensed and will in part define the repeat unit. The characteristics of the pre-condensed resin are described in more detail subsequently.

### Aromatic Polyphenol A2

In a preferred embodiment, the aromatic ring of the aromatic polyphenol bears three hydroxyl functions in the meta position with respect to one another.

Preferably, the two positions ortho to each hydroxyl function are unsubstituted. This is understood to mean that the two carbon atoms located on either side of (in the position ortho to) the hydroxylated carbon atom (i.e., the carbon atom bearing the hydroxyl function) bear a single hydrogen atom.

More preferentially still, the remainder of the aromatic ring of the aromatic polyphenol is unsubstituted. This is understood to mean that the other carbon atoms of the remainder of the aromatic ring (those other than the carbon atoms bearing the hydroxyl functions) bear a single hydrogen atom.

In one embodiment, the aromatic polyphenol comprises several aromatic rings, at least two of them each bearing at least two hydroxyl functions in the meta position with respect to each other, the two positions ortho to at least one of the hydroxyl functions of at least one aromatic ring being unsubstituted.

In a preferred embodiment, at least one of the aromatic rings of the aromatic polyphenol bears three hydroxyl functions in the meta position with respect to one another.

Preferably, the two positions ortho to each hydroxyl function of at least one aromatic ring are unsubstituted.

More preferentially still, the two positions ortho to each hydroxyl function of each aromatic ring are unsubstituted.

Advantageously, the or each aromatic ring of the aromatic polyphenol is a benzene ring.

Mention may in particular be made, as an example of an aromatic polyphenol comprising just one aromatic ring, of resorcinol and phloroglucinol, as a reminder of structural formulae (IV) and (V) respectively:

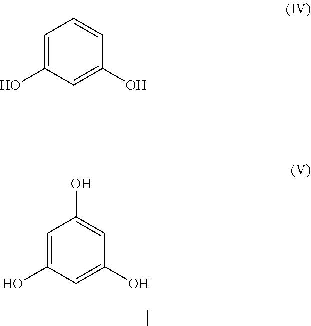 [SMILES: Oc1cccc(O)c1 ; Oc1cc(O)cc(O)c1]

By way of examples, in the case where the aromatic polyphenol comprises several aromatic rings, at least two of these aromatic rings, which are identical or different, are selected from those of general formulae:

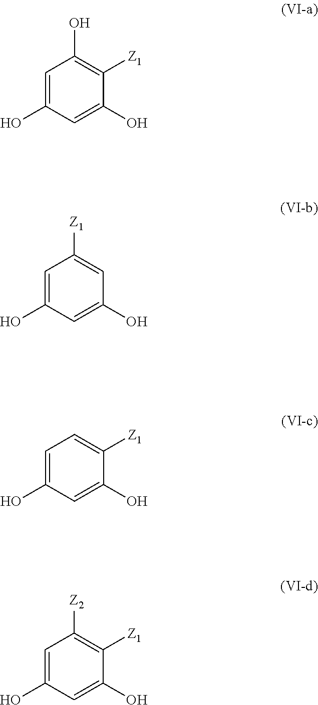

in which the symbols Z₁ and Z₂, which are identical or different, if there are several on the same aromatic ring, represent an atom (for example carbon, sulfur or oxygen) or a bonding group, by definition at least divalent, which connects at least these two aromatic rings to the remainder of the aromatic polyphenol.

Another example of aromatic polyphenol is 2,2′,4,4′-tetrahydroxydiphenyl sulfide of the following structural formula (VII):

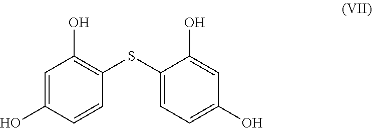 [SMILES: Oc1ccc(Sc2ccc(O)cc2O)c(O)c1]

Another example of an aromatic polyphenol is 2,2′,4,4′-tetrahydroxybenzophenone of structural formula (VIII) below:

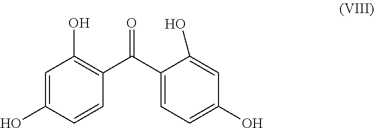 [SMILES: O=C(c1ccc(O)cc1O)c1ccc(O)cc1O]

It is noted that each compound VII and VIII is an aromatic polyphenol comprising two aromatic rings (of formulae VI-c), each of which bears at least two (in this case two) hydroxyl functions in the meta position with respect to each other.

It is noted, in the case of an aromatic polyphenol comprising at least one aromatic ring in accordance with the formula VI-b, that the two positions ortho to each hydroxyl function of at least one aromatic ring are unsubstituted. In the case of an aromatic polyphenol comprising several aromatic rings in accordance with the formula VI-b, the two positions ortho to each hydroxyl function of each aromatic ring are unsubstituted.

According to one embodiment of the invention, the aromatic polyphenol is selected from the group consisting of resorcinol, phloroglucinol, 2,2′,4,4′-tetrahydroxydiphenyl sulfide, 2,2′,4,4′-tetrahydroxybenzophenone, and the mixtures of these compounds.

In a particularly advantageous embodiment, the aromatic polyphenol is phloroglucinol.

In one embodiment, the aromatic polyphenol A2 comprises a pre-condensed resin based on the aromatic polyphenol as described in any one of these embodiments.

This pre-condensed resin is advantageously based on:
at least one aromatic polyphenol as defined previously, and preferably selected from the group consisting of resorcinol, phloroglucinol, 2,2′,4,4′-tetrahydroxydiphenyl sulfide, 2,2′,4,4′-tetrahydroxybenzophenone and mixtures thereof; and
at least one compound capable of reacting with the aromatic polyphenol comprising at least one aldehyde function and/or at least one compound capable of reacting with the aromatic polyphenol comprising at least two hydroxymethyl functions, and preferentially an aromatic aldehyde comprising at least one aromatic ring bearing at least one aldehyde function.

The compound that is capable of reacting with the aromatic polyphenol with compound A1 may be an aromatic compound as defined previously or any other aldehyde. Advantageously, said compound is selected from the group consisting of an aromatic compound comprising an aromatic ring bearing at least two functions, one of these functions being a hydroxymethyl function and the other being an aldehyde function or a hydroxymethyl function, formaldehyde, furfuraldehyde, 2,5-furandicarboxaldehyde, 1,4-benzenedicarboxaldehyde, 1,3-benzenedicarboxaldehyde, 1,2-benzenedicarboxaldehyde and the mixtures of these compounds. Very advantageously, when the compound capable of reacting with the aromatic polyphenol is an aromatic compound comprising an aromatic ring bearing at least two functions, one of these functions being a hydroxymethyl function and the other being an aldehyde function or a hydroxymethyl function, this compound is selected from the group consisting of 5-(hydroxymethyl) furfural, 2,5-di(hydroxymethyl) furan and the mixtures of these compounds.

Thus, in the pre-condensed resin based on aromatic polyphenol, the repeat unit corresponds to the characteristics of the aromatic polyphenol defined above except that at least one of the carbon atoms of the aromatic ring, which was unsubstituted, is connected to another unit.

Irrespective of the compound other than the aromatic polyphenol which is the basis of the pre-condensed resin, this pre-condensed resin is devoid of free formaldehyde. This is because, even in the case where the pre-condensed resin is based on an aromatic polyphenol as described above and on formaldehyde, as the formaldehyde has already reacted with the aromatic polyphenol, the pre-condensed resin is devoid of free formaldehyde liable to be able to react with a compound A1 in accordance with the invention in a subsequent step.

The aromatic polyphenol A2 can also comprise a mixture of a free aromatic polyphenol molecule and of a pre-condensed resin based on aromatic polyphenol, as described above. In particular, the aromatic polyphenol A2 can also comprise a mixture of phloroglucinol and of a pre-condensed resin based on phloroglucinol.

### Aromatic Monophenol A2′

The aromatic monophenol A2′ may be in accordance with two variants. In one variant, the two positions ortho to the hydroxyl function are unsubstituted. In another variant, at least one position ortho to the hydroxyl function, and the position para to the hydroxyl function, are unsubstituted.

Advantageously, in the variant in which at least one position ortho to the hydroxyl function, and the position para to the hydroxyl function, are unsubstituted, a single ortho position is unsubstituted and the position para to the hydroxyl function is unsubstituted.

Preferably, irrespective of the variant, the two positions ortho to the hydroxyl function are unsubstituted. This is understood to mean that the two carbon atoms located on either side of (in the position ortho to) the hydroxylated carbon atom (i.e., the carbon atom bearing the hydroxyl function) bear a single hydrogen atom.

More preferentially still, the remainder of the aromatic ring is unsubstituted. This is understood to mean that the other carbon atoms of the remainder of the aromatic ring (those other than the carbon atoms bearing the hydroxyl functions) bear a single hydrogen atom.

In one embodiment, the aromatic monophenol comprises several six-membered aromatic rings, at least two of them each bearing a single hydroxyl function and, for at least one of the hydroxyl functions, the two positions ortho to the hydroxyl function are unsubstituted or at least one position ortho to the hydroxyl function, and the position para to the hydroxyl function, are unsubstituted.

Preferably, the two positions ortho to each hydroxyl function of at least one six-membered aromatic ring are unsubstituted.

More preferentially still, the two positions ortho to each hydroxyl function of each six-membered aromatic ring are unsubstituted.

More preferentially still, the remainder of each of the aromatic rings is unsubstituted. This is understood to mean that the other carbon atoms of the remainder of each aromatic ring (those other than the carbon atoms bearing the hydroxyl functions or bearing the group which connects the aromatic rings together) bear a single hydrogen atom.

Advantageously, the or each aromatic ring of the aromatic monophenol is a benzene ring.

Preferably, the aromatic monophenol is selected from the group consisting of phenol, ortho-cresol, meta-cresol, para-cresol, ortho-chlorophenol, meta-chlorophenol, para-chlorophenol, 2-hydroxybenzoic acid, 3-hydroxybenzoic acid, 4-hydroxybenzoic acid, 4-vinylphenol, 4-ethylphenol, 4-isopropylphenol, 4-isobutylphenol, para-coumaric acid and the mixtures of these compounds.

In one embodiment, the aromatic monophenol A2′ comprises a pre-condensed resin based on the aromatic monophenol as described in any one of these embodiments.

This pre-condensed resin is advantageously based on:
at least one aromatic monophenol as defined above, and preferentially selected from the group consisting of phenol, ortho-cresol, meta-cresol, para-cresol, ortho-chlorophenol, meta-chlorophenol, para-chlorophenol, 2-hydroxybenzoic acid, 3-hydroxybenzoic acid, 4-hydroxybenzoic acid, 4-vinylphenol, 4-ethylphenol, 4-isopropylphenol, 4-isobutylphenol, para-coumaric acid and the mixtures of these compounds; and
at least one compound that is capable of reacting with the aromatic monophenol comprising at least one aldehyde function and/or at least one compound that is capable of reacting with the aromatic monophenol comprising at least two hydroxymethyl functions, and preferentially an aromatic aldehyde comprising at least one aromatic ring bearing at least one aldehyde function.

The compound that is capable of reacting with the aromatic monophenol may be a compound A1 as defined previously or any other aldehyde. Advantageously, said compound that is capable of reacting with the aromatic polyphenol is selected from the group consisting of an aromatic compound comprising an aromatic ring bearing at least two functions, one of these functions being a hydroxymethyl function, the other being an aldehyde function or a hydroxymethyl function, formaldehyde, furfuraldehyde, 2,5-furandicarboxaldehyde, 1,4-benzenedicarboxaldehyde, 1,3-benzenedicarboxaldehyde, 1,2-benzenedicarboxaldehyde and mixtures of these compounds. Very advantageously, when the compound is an aromatic compound comprising an aromatic ring bearing at least two functions, one of these functions being a hydroxymethyl function and the other being an aldehyde function or a hydroxymethyl function, this compound is selected from the group consisting of 5-(hydroxymethyl) furfural, 2,5-di(hydroxymethyl) furan and the mixtures of these compounds.

Thus, in the pre-condensed resin based on aromatic monophenol, the repeat unit corresponds to the characteristics of the aromatic monophenol which are defined above, except that at least one of the carbon atoms of the six-membered aromatic ring, which was unsubstituted, is connected to another unit.

Whatever the compound other than the aromatic monophenol which is the basis of the pre-condensed resin, this pre-condensed resin is devoid of free formaldehyde. This is because, even in the case where the pre-condensed resin is based on an aromatic monophenol as described previously and on formaldehyde, since the formaldehyde has already reacted with the aromatic monophenol, the pre-condensed resin is devoid of free formaldehyde liable to be able to react with a compound A1 in accordance with the invention in a subsequent step.

The aromatic monophenol A2′ may also comprise a mixture of a free aromatic monophenol molecule and of a pre-condensed resin based on aromatic monophenol, as described previously. In particular, the aromatic monophenol A2′ may also comprise a mixture of phenol and of a pre-condensed resin based on phenol.

### Mixture of Aromatic Polyphenol A2 and of Aromatic Monophenol A2′

The phenol A21 may also comprise a mixture of an aromatic polyphenol A2 and of an aromatic monophenol A2′, as described previously.

Preferably, the phenol A21 comprises a mixture of an aromatic polyphenol and of a pre-condensed resin based on aromatic polyphenol.

### Elastomer Latex

The adhesive composition also comprises an elastomer latex, preferably an unsaturated elastomer latex. Such an elastomer latex makes it possible to provide an elastomeric physical interface when the adhesive composition is used for coating elements intended to be embedded in an elastomer matrix. When the elastomer latex is unsaturated, it also provides a chemical interface by means of the unsaturations capable of forming bridges with the crosslinking system of the elastomer matrix.

It is recalled that a latex is a stable dispersion of microparticles of elastomer(s) in suspension in a generally aqueous solution. An elastomer latex is thus a composition in a liquid state comprising a liquid solvent, generally water, and at least one elastomer or rubber dispersed in the liquid solvent so as to form a suspension. Thus, the latex is not a rubber composition which comprises an elastomer or rubber matrix in which at least one other component is dispersed. A rubber composition is in a plastic state in the uncured (non-crosslinked) state and in an elastic state in the cured (crosslinked) state, but never in a liquid state, unlike a latex.

Unsaturated (that is to say, bearing carbon-carbon double bonds) elastomer latices, notably diene elastomer latices, are well known to those skilled in the art. They notably form the elastomeric base of the RFL adhesives described in the introduction to the present specification.

The unsaturated elastomer of the latex is preferentially a diene elastomer, more preferentially a diene elastomer selected from the group consisting of butadiene copolymers, styrene-butadiene copolymers, vinyl pyridine-styrene-butadiene terpolymers, natural rubber, with the exception of chlorinated natural rubber, and the mixtures of these elastomers.

Advantageously, this step of depositing the aqueous adhesive composition is followed by a step of drying the GRP plastic at a temperature above or equal to 120° C. for at least 5 seconds followed by a heat treatment at a temperature above or equal to 180° C. for at least 5 seconds.

### COMPOSITE ACCORDING TO THE INVENTION

The invention also relates to an elastomer composite reinforced with at least one or more sized glass-reinforced plastic (GRP) strands as defined previously. The elastomer matrix is based on an elastomer composition comprising at least one elastomer and another constituent.

Preferably, the elastomer composition comprises a diene elastomer. Elastomer or rubber (the two terms being synonyms) of the “diene” type is understood to mean, generally, an elastomer resulting, at least in part (i.e., a homopolymer or a copolymer), from diene monomers (monomers bearing two conjugated or non-conjugated carbon-carbon double bonds).

The elastomer compositions can contain just one diene elastomer or a mixture of several diene elastomers, it being possible for the diene elastomer(s) to be used in combination with any type of synthetic elastomer other than a diene elastomer, indeed even with polymers other than elastomers, for example thermoplastic polymers.

In a first embodiment preferentially intended for a tyre use, the elastomer composition comprises a diene elastomer selected from the group consisting of polybutadienes (BRs), natural rubber (NR), synthetic polyisoprenes (IRs), the various butadiene copolymers, the various isoprene copolymers and the mixtures of these elastomers.

Such copolymers are more preferentially selected from the group consisting of butadiene/styrene copolymers (SBRs), whether the latter are prepared by emulsion polymerization (ESBRs) or solution polymerization (SSBRs), isoprene/butadiene copolymers (BIRs), isoprene/styrene copolymers (SIRs) and isoprene/butadiene/styrene copolymers (SBIRs).

In a second embodiment preferentially intended for use in belts, the elastomeric composition comprises an elastomer selected from the group consisting of an elastomer of a-olefin ethylene type, a polychloroprene elastomer and mixtures of these elastomers, one or more other elastomers. The elastomeric composition may also comprise one or more other components.

Advantageously, the elastomer of ethylene/a-olefin type is selected from the group consisting of ethylene/propylene copolymers (EPMs), ethylene/propylene/diene copolymers (EPDMs) and mixtures of these copolymers.

Preferably, the elastomer composition comprises a reinforcing filler.

When a reinforcing filler is used, use may be made of any type of reinforcing filler known for its abilities to reinforce an elastomer composition which can be used for the manufacture of tyres, for example an organic filler, such as carbon black, a reinforcing inorganic filler, such as silica, or else a blend of these two types of filler, in particular a blend of carbon black and silica.

Any carbon black conventionally used in tyres (“tyre-grade” black) is suitable as carbon black. Mention will more particularly be made, for example, of the reinforcing carbon blacks of the 100, 200 or 300 series (ASTM grades).

In the case of the use of carbon blacks with an isoprene elastomer, the carbon blacks might, for example, be already incorporated in the isoprene elastomer in the form of a masterbatch (see, for example, applications WO 97/36724 and WO 99/16600).

Mention may made, as examples of organic fillers other than carbon blacks, of functionalized polyvinylaromatic organic fillers, as described in applications WO-A-2006/069792 and WO-A-2006/069793.

The term “reinforcing inorganic filler” should be understood, in the present application, by definition, as meaning any inorganic or mineral filler (regardless of its colour and its origin (natural or synthetic)), also known as “white filler”, “clear filler” or indeed even “non-black filler”, in contrast to carbon black, capable of reinforcing by itself alone, without means other than an intermediate coupling agent, an elastomer composition, in other words capable of replacing, in its reinforcing role, a conventional tyre-grade carbon black. Such a filler is generally characterized, in a known manner, by the presence of hydroxyl (—OH) groups at its surface.

The physical state in which the reinforcing inorganic filler is provided is not important, whether it is in the form of a powder, of micropearls, of granule, of beads or any other suitable densified form. Of course, “reinforcing inorganic filler” is also understood to mean mixtures of different reinforcing inorganic fillers, in particular of highly dispersible siliceous and/or aluminous fillers such as described hereinafter.

Mineral fillers of the siliceous type, in particular silica (SiO₂), or of the aluminous type, in particular alumina (Al₂O₃), are suitable in particular as reinforcing inorganic fillers. The silica used may be any reinforcing silica known to those skilled in the art, in particular any precipitated or fumed silica having a BET specific surface area and a CTAB specific surface area both of less than 450 m²/g, preferably from 30 to 400 m²/g. As highly dispersible precipitated silicas (HDSs), mention will be made, for example, of the Ultrasil 7000 and Ultrasil 7005 silicas from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

Finally, a person skilled in the art will understand that, as filler equivalent to the reinforcing inorganic filler described in the present section, use might be made of a reinforcing filler of another nature, in particular organic nature, provided that this reinforcing filler is covered with an inorganic layer, such as silica, or else comprises, at its surface, functional sites, in particular hydroxyl sites, requiring the use of a coupling agent in order to establish the bond between the filler and the elastomer.

Preferably, the content of total reinforcing filler (carbon black and/or reinforcing inorganic filler, such as silica) is within a range from 5 to 120 phr, more preferentially from 5 to 100 phr and more preferentially still from 5 to 90 phr.

The carbon black can advantageously constitute the sole reinforcing filler or the predominant reinforcing filler. Of course, it is possible to use just one carbon black or a blend of several carbon blacks of different ASTM grades. The carbon black can also be used as a blend with other reinforcing fillers and in particular reinforcing inorganic fillers as described above, and in particular silica.

When an inorganic filler (for example silica) is used in the rubber composition, alone or as a blend with carbon black, its content is within a range from 0 to 70 phr, preferentially from 0 to 50 phr, in particular also from 5 to 70 phr, and more preferentially still this proportion varies from 5 to 50 phr, particularly from 5 to 40 phr.

Preferably, the elastomer composition comprises various additives.

The rubber compositions can also comprise all or part of the usual additives customarily used in elastomer compositions intended for the manufacture of tyres, such as, for example, plasticizers or extender oils, whether the latter are aromatic or non-aromatic in nature, pigments, protective agents, such as antiozone waxes, chemical antiozonants or antioxidants, antifatigue agents or else adhesion promoters.

Preferably, the elastomer composition comprises a crosslinking system, more preferentially a vulcanization system.

In the first embodiment preferentially intended for use in tyres, the elastomer composition comprises a vulcanization system.

The vulcanization system comprises a sulfur-donating agent, for example sulfur.

Preferably, the vulcanization system comprises vulcanization activators, such as zinc oxide and stearic acid.

Preferably, the vulcanization system comprises a vulcanization accelerator and/or a vulcanization retarder.

Advantageously, the composite is such that the elastomer matrix is based on an elastomer composition comprising a crosslinking system comprising a content of molecular sulfur ranging from 1 to 5 phr. Molecular sulfur is understood to mean sulfur resulting from an Sₙ compound with n>2. Specifically, the inventors put forward the hypothesis that there is competition between adhesion by the adhesive composition and adhesion by the copper and zinc sulfide dendrites. Now, this competition has a tendency to reduce the general level of the adhesion. The more the content of sulfur present in the elastomeric matrix is reduced, the more this competition is reduced, and the more the level of adhesion by the sole adhesive composition is promoted.

Very advantageously, the molecular sulfur content of the crosslinking system of the elastomeric composition is less than or equal to 4 phr, preferably less than or equal to 3 phr and more preferentially less than or equal to 2.5 phr. In addition to further reducing the competition between the adhesion by the adhesive composition and the adhesion by the copper and zinc sulfide dendrites, the shelf life of the elastomeric composition at room temperature is improved, avoiding the risks of prevulcanization which would arise if a higher sulfur content were used.

Very advantageously, the molecular sulfur content of the crosslinking system of the elastomer composition is greater than or equal to 1.5 phr, preferably greater than or equal to 2 phr.

The sulfur content is measured by elemental analysis, using the Thermo Scientific Flash 2000 microanalyser. The analysis comprises a step of combustion of the sample and then a step of separation of the compounds formed. Approximately 1 mg of sample is introduced into the microanalyser, where it is subjected to a flash combustion of 1000° C. under oxygen. The gases formed are then oxidized by virtue of the excess oxygen and of a tungstic anhydride catalyst. A step of reduction by passing over copper subsequently makes it possible to trap the excess oxygen and to reduce the nitrogen oxides to N₂ and also the sulfites to sulfur dioxide SO₂. The water is trapped and the compounds N₂, CO₂ and SO₂ formed are subsequently separated on a chromatographic column and then detected with a katharometer. The total sulfur is quantified by measurement of the area of the SO₂ peak, after calibration with standards.

The combined vulcanization accelerators, retarders and activators are used at a preferential content within a range from 0.5 to 15 phr. The vulcanization activator(s) is/are used at a preferential content within a range from 0.5 to 12 phr.

The crosslinking system proper is preferentially based on sulfur and on a primary vulcanization accelerator, in particular on an accelerator of the sulfenamide type. Additional to this vulcanization system are various known secondary vulcanization accelerators or vulcanization activators, such as zinc oxide, stearic acid, guanidine derivatives (in particular diphenylguanidine), and the like.

Use may be made, as (primary or secondary) accelerator, of any compound capable of acting as accelerator of the vulcanization of diene elastomers in the presence of sulfur, in particular accelerators of the thiazole type and also their derivatives, accelerators of thiuram type and of zinc dithiocarbamate type. These accelerators are more preferentially selected from the group consisting of 2-mercaptobenzothiazyl disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBBS”), N-(tert-butyl)-2-benzothiazolesulfenimide (abbreviated to “TBSI”), zinc dibenzyldithiocarbamate (abbreviated to “ZBEC”) and the mixtures of these compounds. Preferably, use is made of a primary accelerator of the sulfenamide type.

In the second embodiment preferentially intended for use in belts, the crosslinking system is substantially free of sulfur, and advantageously comprises a peroxide, preferably an organic peroxide. Advantageously, the peroxide content ranges from 0.5 to 8 phr. Advantageously, the crosslinking system comprises a co-crosslinking agent, preferably sulfur or triallyl cyanurate. Advantageously, the content of the co-crosslinking agent ranges from 0.5 to 5 phr.

### TYRE ACCORDING TO THE INVENTION

The invention also relates to a tyre. The elastomeric composite of the invention may advantageously be used to reinforce tyres for all types of vehicles, in particular passenger vehicles or industrial vehicles, such as heavy-duty vehicles.

### BELT ACCORDING TO THE INVENTION

The invention also relates to a belt. For example, such a belt may be a power transmission belt.

The invention will be better understood on reading the following description, given solely by way of non-limiting example and with reference to the drawings, in which:

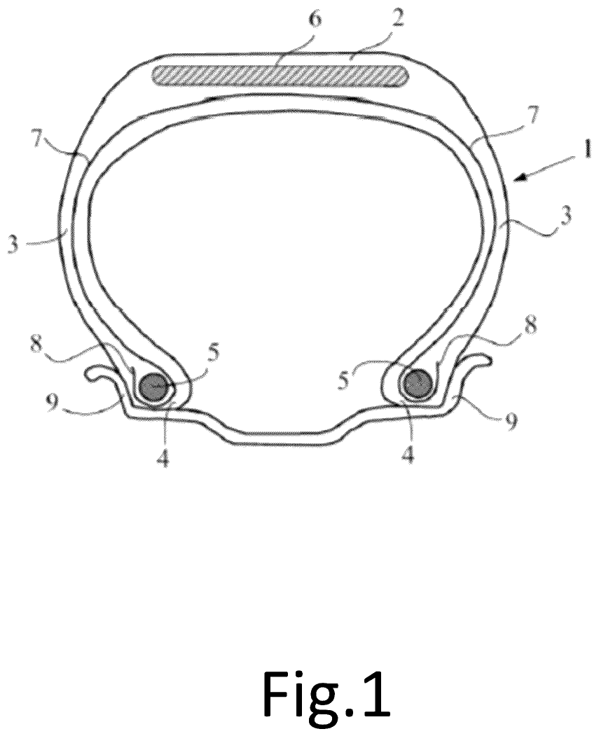

FIG. 1 is a diagram of a tyre according to the invention; and

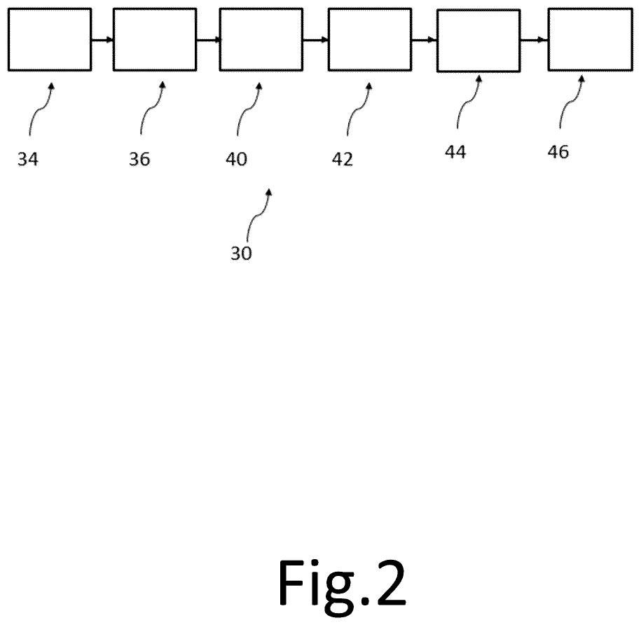

FIG. 2 is a schematic representation of the process for sizing one or more GRP strands comprising steps of a process according to the invention.

The appended FIG. 1 represents very schematically (without observing a specific scale) a radial section of a tyre in accordance with the invention for a passenger vehicle.

This tyre 1 comprises a crown 2 reinforced by a crown reinforcement or belt 6, two sidewalls 3 and two beads 4, each of these beads 4 being reinforced with a bead wire 5. The crown 2 is surmounted by a tread, not represented in this schematic figure. A carcass reinforcement 7 is wound around the two bead wires 5 in each bead 4, the turn-up 8 of this reinforcement 7 being, for example, positioned towards the outside of the tyre 1, which is represented here fitted onto its rim 9. The carcass reinforcement 7 is, in a manner known per se, formed of at least one ply reinforced by “radial” cords, for example textile cords, that is to say that these cords are positioned virtually parallel to one another and extend from one bead to the other so as to form an angle of between 80° and 90° with the median circumferential plane (plane perpendicular to the axis of rotation of the tyre which is located midway between the two beads 4 and passes through the middle of the crown reinforcement 6).

This tyre 1 of the invention has for example the essential feature that at least one crown reinforcement 6 and/or the carcass reinforcement 7 comprises the elastomer composite according to the invention. The tyre has the preferential feature that at least its belt and/or its carcass reinforcement comprises a multilayer laminate according to the invention, consisting of at least one multicomposite reinforcer according to the invention positioned between and in contact with two layers of diene rubber composition. According to one particular embodiment of the invention, this composite of the invention may be used in the form of parallel sections positioned under the tread, as described in the patent EP 1 167 080. According to another possible exemplary embodiment of the invention, it is the bead zone that can be reinforced with such a composite; it is, for example, the bead wires that could be formed, in whole or in part, of a composite according to the invention.

The belt according to the invention has, for example, the essential feature that it comprises an elastomer composite according to the invention.

Needless to say, the invention relates to the objects described previously, namely the elastomer composite and the tyre or belt comprising it, both in the uncured state (before crosslinking) and in the cured state (after crosslinking).

FIG. 2 depicts one embodiment of a facility for sizing one or more GRP strands according to the invention, denoted by the general reference 30.

The production facility 30 is capable of producing one or more sized GRP strands.

The facility 30 comprises, in the run direction of the GRP strand(s) through the facility 30, from upstream to downstream, means 34 for upstream storage of the GRP strands, a first aqueous pre-bonding bath 36 comprising a composition based on an epoxy compound and on a blocked diisocyanate compound into which the GRP strand(s) are dipped, a device 40 for drying the pre-bonded strands by heat treatment, a second bath 42 consisting of an aqueous adhesive composition for depositing this adhesive composition on the GRP strands, a device 44 for the heat treatment of the sized GRP strands and means 46 for the downstream storage of the heat-treated sized GRP.

The upstream storage means 34 and downstream storage means 46 each comprise a reel for storing the GRP strands, making it possible, respectively, to unwind and to wind up the GRP strands.

An example of a process for sizing one or more glass-reinforced plastic (GRP) strands will now be described.

During this process, a pre-bonding step is carried out in a first bath based on an epoxy resin and on a blocked diisocyanate in aqueous solution, for example based on polyglycerol polyglycidyl ether and on N,N′-(methylenedi-p-phenylene)bis[hexahydro-2-oxo-1H-azepine-1-carboxamide 4,4′-diisocyanate. The ingredients are introduced into the water with stirring, for example in the following order: 1.5% by weight of polyglycerol polyglycidyl ether (for example Denacol EX-512 from Nagase Chemicals), 0.02% zinc acetate, 0.08% antifoaming agent, 15.15% of a 20% solution of N,N′-(methylenedi-p-phenylene) bis[hexahydro-2-oxo-1H-azepine-1-carboxamide 4,4′-diisocyanate and 83.6% by weight of water.

To do this, several glass-reinforced plastic (GRP) strands are brought into contact with the first bath.

Next, the glass-reinforced plastic (GRP) strands are dried, for example by passing through a high-frequency heating tunnel or oven (for example for 20 s at 170° C.) and they undergo a heat treatment (for example for 30 s at 220° C.).

Next, a step of depositing the aqueous adhesive composition comprising water, a mixture of unsaturated elastomer latices and a resin based on phloroglucinol and 1,4-benzenedicarboxaldehyde is carried out. The proportions of these various constituents are described below.

To do this, several glass-reinforced plastic (GRP) strands are brought into contact with the adhesive composition. To do this, the glass-reinforced plastic (GRP) strand, is continuously unwound from the storage reel of the storage means 34 and the glass-reinforced plastic (GRP) strands are run through the first bath, next they pass through a heat treatment device then through a second bath comprising the aqueous adhesive composition and they pass through a heat treatment device, for example by passing through a heating tunnel or oven (for example for 20 s at 170° C.) and they undergo a heat treatment (for example for 30 s at 220° C.).

### COMPARATIVE TESTS

### Adhesion test

Various control, sized glass-reinforced plastic (GRP) strands T, T1, T1′, T2 and T2′ and sized, glass-reinforced plastic (GRP) strands C1 and C2 according to the invention were tested by means of a test aimed at measuring the pull-out force of these sized glass-reinforced plastic (GRP) strands embedded in an elastomer matrix.

The glass-reinforced plastic (GRP) strands were coated with each of the protocols described below in Table 1 below, then dried in a drying oven at 170° C. for 20 s. The adhesive composition was then crosslinked by passing the glass-reinforced plastic (GRP) strands through a treatment oven at 220° C. for 30 s. The assembly was then unified by curing with a natural rubber composition by means of a vulcanization heat treatment, in order to form composite test specimens as described below.

The quality of the bonding between the rubber composition and the glass-reinforced plastic (GRP) strands is subsequently determined by a test in which the force necessary to extract sections of glass-reinforced plastic (GRP) strands from the vulcanized rubber composition is measured. This rubber composition is a conventional composition which can be used for the calendering of tyre carcass reinforcement plies, these plies comprising glass-reinforced plastic (GRP) strands embedded in an elastomer matrix based on natural rubber, carbon black and standard additives.

More specifically, the vulcanizate is a block of an elastomer composition consisting of two sheets measuring 200 mm by 4.5 mm and with a thickness of 3.5 mm, applied against each other before curing (the thickness of the resulting block is then 7 mm). It is during the production of this block that the glass-reinforced plastic (GRP) strands (15 sections in total) are imprisoned between the two rubber sheets of the elastomer composition in the uncured state, an equal distance apart and while allowing a cord end to project out on either side of these sheets with a length sufficient for the subsequent tensile testing. The block comprising the glass-reinforced plastic (GRP) strands is then placed in a suitable mould and then cured under pressure. The curing temperature and the curing time are adapted to the intended test conditions and left to the discretion of those skilled in the art; by way of example, in the present case, the block is cured at 160° C. for 15 min.

On conclusion of the curing, the test specimen, thus consisting of the vulcanized block and the 15 sections of glass-reinforced plastic (GRP) strands, is placed between the jaws of a suitable tensile testing machine in order to make it possible to test each section individually, at a given rate and a given temperature (for example, in the present case, at 100 mm/min and 20° C.).

The adhesion levels are characterized by measuring the “pull-out” force (denoted by Fmax0) for pulling the glass-reinforced plastic (GRP) strands out of the test specimen. For the pull-out force (Fmax0), an adhesion value was set at 100 for the control T, which represents the conventional process for sizing glass-reinforced plastics as described in application WO2016116457.

The results of the adhesion tests carried out on the sized glass-reinforced plastic (GRP) strands are summarized in Table 1 below.

### Moisture Sensitivity Test

Each glass-reinforced plastic (GRP) strand was coated with the adhesive composition tested according to the process described below in Table 1 with or without the 1^{st} bath. Each sized glass-reinforced plastic (GRP) strand was dried in a drying oven at 170° C. for 20 seconds.

The adhesive composition was then crosslinked by passing the sized glass-reinforced plastic (GRP) strands through a treatment oven at 220° C. for 30 seconds.

The resistance of the interface to wet conditions is characterized by measuring the breaking strength of the sized glass-reinforced plastic (GRP) strands (denoted Fmax0) and the breaking strength of the sized glass-reinforced plastic (GRP) strands after heat treatment in an oven for 70 h at 90° C. and 90% humidity level (denoted Fmax70). The breaking strength Fmax0 is arbitrarily set at 100. The value of the breaking strength Fmax70 of each sized glass-reinforced plastic (GRP) strand is necessarily less than 100, and even more so, the more sensitive the sized glass-reinforced plastic (GRP) strand was to wet conditions.

The decline D, expressed as a percentage, corresponding to the loss of breaking strength between Fmax0 and Fmax70, was calculated. D is such that D=(1-Fmax70/Fmax0)×100. The lower the decline value D, the lower the sensitivity of the sized glass-reinforced plastic (GRP) strand to wet conditions.

The results of the tests of sensitivity to wet conditions carried out on the sized glass-reinforced plastic (GRP) strands are summarized in Table 1 below.

The values of the various compounds are in % by weight of solids for a formula on a basis of 100 for the first and second baths.

TABLE 1

| Sized glass-reinforced plastic (GRP) strand | | | | | | | |
|---|---|---|---|---|---|---|---|
| T | T1 | T1′ | C1 | T2″ | C2 | T2 | T2′ |

1^{st} bath

| | | | | | | | | |
|---|---|---|---|---|---|---|---|---|
| Epoxy (1) | 1.15 | 0.5 | — | 1.15 | 1.15 | 1.15 | 0.5 | — |
| Blocked diisocyanate (2) | 15.15 | — | — | 15.15 | 15.15 | 15.15 | — | — |
| Zinc acetate | 0.02 | — | — | 0.02 | 0.02 | 0.02 | — | — |
| Sodium hydroxide | — | 0.06 | — | — | — | — | 0.06 | — |
| Water | 83.6 | 98.8 | — | 83.6 | 83.6 | 83.6 | 98.8 | — |

2^{nd} bath
Compound A1

| | | | | | | | | |
|---|---|---|---|---|---|---|---|---|
| 1,4- | — | — | — | — | 0.9 | 0.9 | 0.9 | 0.9 |
| benzenedicarboxaldehyde (3) | | | | | | | | |

Aldehyde

| | | | | | | | | |
|---|---|---|---|---|---|---|---|---|
| Formaldehyde (4) | 3.3 | 3.3 | 3.3 | 3.3 | — | — | — | — |

Compound A2

| | | | | | | | | |
|---|---|---|---|---|---|---|---|---|
| Phloroglucinol (5) | — | — | — | — | 1.7 | 1.7 | 1.7 | 1.7 |
| Resorcinol (6) | 1.9 | 1.9 | 1.9 | 1.9 | — | — | — | — |

Other compounds

| | | | | | | | | |
|---|---|---|---|---|---|---|---|---|
| Sodium hydroxide | 0.1 | 0.1 | 0.1 | 0.1 | 0.8 | 0.8 | 0.8 | 0.8 |
| Blocked | 9.7 | 9.7 | 9.7 | 0 | 9.7 | 0 | 0 | 0 |
| diisocyanate (2) | | | | | | | | |
| Aqueous ammonia | 2.6 | 2.6 | 2.6 | 2.6 | 2.6 | 2.5 | 2.5 | 2.5 |
| Vinyl pyridine- | 41.5 | 41.5 | 41.5 | 41.5 | 41.5 | 39.5 | 39.5 | 39.5 |
| styrene-butadiene terpolymer | | | | | | | | |
| Water | 41.0 | 41.0 | 41.0 | 50.6 | 42.7 | 54.6 | 54.6 | 54.6 |

Adhesion test

| | | | | | | | | |
|---|---|---|---|---|---|---|---|---|
| Fmax0 | 100 | 146 | 103 | 85 | 85 | 72 | 65 | 74 |

Moisture sensitivity test

| | | | | | | | | |
|---|---|---|---|---|---|---|---|---|
| D (%) | 27 | 26 | 53 | 25 | 34 | 28 | 66 | 76 |

(1) Polyglycerol polyglycidyl ether ([EX512 supplied by Nagase])
(2) DiNCO 4,4′-diphenylmethylene diisocyanate ([Grilbond IL-6 50% supplied by EMS])
(3) 1,4-Benzenedicarboxaldehyde (from the company ABCR; 98% purity)
(4) Formaldehyde (from Caldic; diluted to 36%)
(5) Phloroglucinol (from Alfa Aesar; 99% purity)
(6) Resorcinol (Sumitomo CHIBA)

It is observed that the level of adhesion remains high regardless of the 1^{st} bath used, and even without the 1^{st} bath (T1′).

It is observed that the composites according to the invention C1 and C2 have a breaking strength Fmax0, admittedly lower than the controls T, T1, T1′ and T2″ using blocked diisocyanates in the second bath, but nevertheless sufficient to ensure satisfactory adhesion that is compatible with use in tyres or belts.

It is also observed that the presence of blocked diisocyanate in the first bath limits the decline and this is true regardless of the 2^{nd} bath used (T, T2″, C1 and C2). and that the presence of diisocyanate has an effect on the resistance to wet conditions if T1 is compared to C1 and T2 is compared to C2.

The presence of blocked diisocyanate therefore has an effect on the moisture resistance.

Thus, the pre-bonding step is an essential step in order, on the one hand, to maintain a good level of adhesion initially and, on the other hand, to guarantee resistance of the adhesive interface to wet conditions, without however using products that have a negative impact on the environment.

The process according to the invention thus makes it possible to adhere the composite C2 according to the invention satisfactorily to elastomer matrices, without these requiring the use of an adhesive composition in combination with products which have a negative impact on the environment. Furthermore, the adhesion of this composite is relatively high and it is sparingly degraded by wet conditions.

The invention is not limited to the embodiments described above.

1.-15. (canceled)

16. A process for sizing one or more strands of glass-reinforced plastic comprising the following steps:
(a) pre-bonding one or more strands of glass-reinforced plastic by dipping the one or more strands in a first aqueous bath comprising a composition based on:
an epoxy compound; and
a blocked diisocyanate compound; and
(b) depositing on the glass-reinforced plastic by dipping the one or more strands in a second bath comprising an aqueous adhesive composition based on:
at least one compound A1, the compound A1 comprising at least one aldehyde function;
at least one phenol A21; and
at least one unsaturated elastomer latex comprising at least one elastomer selected from the group consisting of butadiene copolymers, styrene-butadiene copolymers, vinyl pyridine-styrene-butadiene terpolymers, natural rubber, with the exception of chlorinated natural rubber, and mixtures thereof,
wherein a content of blocked diisocyanate compound in the aqueous adhesive composition of the second bath is at a weight content of less than 0.50%.

17. The process according to claim 16, wherein the blocked diisocyanate compound in the aqueous adhesive composition of the second bath is at a weight content of less than 0.40%.

18. The process according to claim 16, wherein the epoxy compound is selected from the group consisting of diethylene glycol diglycidyl ether, polyethylene diglycidyl ether, polypropylene glycol diglycidyl ether, neopentyl glycol diglycidyl ether, 1,6-hexanediol diglycidyl ether, glycerol polyglycidyl ether, trimethylolpropane polyglycidyl ether, polyglycerol polyglycidyl ether, pentaerythritol polyglycidyl ether, diglycerol polyglycidyl ether, sorbitol polyglycidyl ether and isosorbide diglycidyl ether.

19. The process according to claim 16, wherein the blocked diisocyanate compound is selected from the group consisting of diphenylmethane diisocyanates and polyphenylene polymethylene polyisocyanates.

20. The process according to claim 16, wherein compound A1 is formaldehyde.

21. The process according to claim 16, wherein compound A1 comprises at least one aromatic ring bearing at least one aldehyde function.

22. The process according to claim 21, wherein compound Al bears at least two aldehyde functions.

23. The process according to claim 21, wherein compound Al is selected from the group consisting of 1,2-benzenedicarboxaldehyde, 1,3-benzenedicarboxaldehyde, 1,4-benzenedicarboxaldehyde, 2-hydroxybenzene-1,3,5-tricarbaldehyde and mixtures thereof.

24. The process according to claim 16, wherein the at least one phenol A21 is selected from the group consisting of:
an aromatic polyphenol A2 comprising at least one aromatic ring bearing at least two hydroxyl functions in a meta position relative to one another, two positions ortho to at least one of the hydroxyl functions being unsubstituted;
an aromatic monophenol A2′ comprising at least one six-membered aromatic ring bearing a single hydroxyl function with:
two positions ortho to the single hydroxyl function being unsubstituted, or
at least one position ortho to the single hydroxyl function and a position para to the single hydroxyl function being unsubstituted; and
a mixture of A2 and A2′.

25. The process according to claim 24, wherein the aromatic polyphenol A2 is selected from the group consisting of resorcinol, phloroglucinol, 2,2′,4,4′-tetrahydroxydiphenyl sulfide, 2,2′,4,4′-tetrahydroxybenzophenone and mixtures thereof.

26. The process according to claim 16, further comprising, following step a), drying the glass-reinforced at a temperature above or equal to 120° C. for at least 5 seconds followed by a heat treatment at a temperature above or equal to 180° C. for at least 5 seconds.

27. The process according to claim 16, further comprising, following step b), drying the glass-reinforced plastic by drying at a temperature above or equal to 120° C. for at least 5 seconds followed by a heat treatment at a temperature above or equal to 180° C. for at least 5 seconds.

28. An elastomer composite reinforced with at least one or more sized glass-reinforced plastic strands embedded in an elastomer matrix, wherein the at least one or more sized glass-reinforced plastic strands are obtained by the process according to claim 16.

29. A tire comprising the elastomer composite according to claim 28.

30. A belt comprising the elastomer composite according to claim 28.
